(19) United States
(12) Patent Application Publication
(10) Pub. No.: US 2012/0109846 A1
(43) Pub. Date: May 3, 2012

(54) WEIGHTED CURRENCY PORTFOLIO AND INDEX

(76) Inventors: Ronald L. Leven, NY, NY (US); Paromita Roy, NY, NY (US)

(21) Appl. No.: 12/915,522

(22) Filed: Oct. 29, 2010

(51) Int. Cl. G06Q 40/00

(52) U.S. Cl. 705/36 R; 705/35; 705/37

(57) ABSTRACT

A computerized method and apparatus, involving a focus currency and a group of currencies other than the focus currency which define non-focus currencies, involves calculating weights for each of the non-focus currencies and performing a covariance adjustment to the weights of each of the non-focus currencies to obtain final currency weights for each of the non-focus currencies, whereby the final currency weights define a portfolio that allows an investor to take a position on the focus currency without taking a position relative to any particular non-focus currency in the group.

### FIELD OF THE INVENTION

This application generally relates to computerized analysis in the area of international finance and, more particularly, to computerized analysis involving multiple currencies.

### BACKGROUND

In 1978, the U.S. Federal Reserve Board (the “Fed”) introduced its first dollar index. In 1998, the Federal Reserve Board introduced a broad trade weighted dollar index and sub-components for “major currencies” and “other important trading partners” to replace their original dollar index. The 1998 index adjusted for the introduction of the euro and was intended to indicate the broad competitiveness of US manufacturing. Both the 1978 and 1998 Fed dollar indicies use trade flows to determine the weights for each currency component of the index.

The 1978 dollar index has limitations as an indicator of general dollar performance because the weights are based on 30-year old trade flows and utilize each country's global trade. The consequence is that some currencies, especially the Canadian dollar (“CAD”) have a weight that is low relative to Canada's bilateral importance to the United States, and the Euro (EUR) currency is dominant. Not surprisingly due to this dominance, the Fed's original dollar index has a 92% correlation with EUR performance since 1999. The strong link of the original index to the EUR compromises the index's use as a general indicator of dollar performance.

The revised Fed index is more balanced than the original because it uses bilateral, rather than total trade which may be more relevant for assessing competitiveness. However, the revised Fed index may still be overly dominated by continental European currencies.

As an alternative, the Fed has considered, and seemingly rejected, use of an index alternatively based upon capital flow.

### SUMMARY

We have devised a way to construct a currency portfolio or index that we believe is more indicative of market performance of a particular currency, the “focus currency,” relative to a group of other specified currencies and, thus, generally allows one to take a position on the focus currency relative to the group as a whole, without taking a position relative to any particular other currency or currencies in the group.

One example aspect involves a computerized method performed with respect to a focus currency of a focus country, identified from a set of free-trading currencies of countries, and a group of currencies from the set other than the focus currency in which the group defines non-focus currencies. The method involves calculating competitive weights for each of the non-focus currencies wherein each weight reflects competition between goods of the focus country and i) goods of each non-focus country in the non-focus country, and ii) goods of each non-focus country in each third-party country of the group, as a percentage of all market trading partners, calculating capital weights for each of the non-focus currencies such that each capital weight reflects investment holdings of the focus country in non-focus countries of the group and investment holdings of non-focus countries of the group in the focus country as a percentage of total holdings, calculating currency weights as a weighted average of the competitive weights and the capital weights according to a specified weighting bias, performing a covariance adjustment to the currency weights of each of the non-focus currencies to obtain final currency weights for each of the non-focus currencies, whereby the final currency weights define a portfolio that allows an investor to take a position on the focus currency without taking a position relative to any particular non-focus currency in the group.

Another aspect involves a method including specifying a focus currency from among a set of free-trading currencies of countries, and a group of currencies other than the focus currency from among the set, determining, for each of the currencies in the group relative to the focus currency, an import trade weight value as a function of total imports into the country of the focus currency that comes from each of the countries in the group within a specified period. The method further involves determining, for each of the currencies in the group relative to the focus currency, an export trade weight value as a function of both focus country share of exports to each country in the group, and manufacturing that is consumed within each country in the group. The method also includes determining, for each of the currencies in the group, total trade weight values as a function of the import trade weight values and the export trade weight values. The method further includes storing the total trade weight values in memory. In addition, the method includes determining i) investor external flow weight values as a function of the focus country holdings of investments of each country in the group, ii) investor internal flow weight values as a function of each country in the group's holdings of focus country investments, and iii) total investor flow weight values as a function of the investor external flow weight values and the investor internal flow weight values. The method also involves storing the total investor flow weight values in the memory, for each of the currencies in the group, calculating unadjusted currency weight values as a combination of the stored total trade weight values and the stored total investor flow weight values, and modifying the unadjusted currency weight values based upon a covariance adjustment calculation to obtain a covariance adjusted, final currency weighted investable portfolio of currencies.

Still another aspect involves an apparatus for generating a currency index. The apparatus includes a currency transaction data processing system including at least one processor and storage, accessible by the processor, the storage including instructions which when executed by the at least one processor will cause the currency transaction data processing system to repeatedly, multiply spot rates for a defined group of currencies by covariance adjusted currency weights calculated for the defined group of currencies, obtained from storage, to obtain current weighted currency values for each of the currencies in the defined group, normalize the current weighted currency values to obtain normalized currency values, and generate the currency index as an average of the normalized currency values.

Yet another aspect involves a computerized method performed with respect to a focus currency of a focus country, identified from a set of free-trading currencies of countries, and a group of currencies from the set other than the focus currency, wherein the group defines non-focus currencies each corresponding to a non-focus country. The method involves calculating capital weights for each of the non-focus currencies such that each capital weight reflects investment holdings of the focus country in non-focus countries of the group and investment holdings of non-focus countries of the group in the focus country as a percentage of total holdings, and performing a covariance adjustment to the capital weights of each of the non-focus currencies to obtain final currency weights for each of the non-focus currencies, whereby the final currency weights define a portfolio that allows an investor to take a position on the focus currency without taking a position relative to any particular non-focus currency in the group.

Still another aspect involves an apparatus for generating a currency index. The apparatus involves a currency transaction data processing system including at least one processor and storage, accessible by the processor, the storage including instructions which when executed by the at least one processor will cause the currency transaction data processing system to repeatedly multiply spot rates for a defined group of currencies by covariance adjusted currency weights, obtained from storage and previously calculated from capital weighting for the defined group of currencies, to generate current weighted currency values for each of the currencies in the defined group, normalize the current weighted currency values to obtain normalized currency values, and generate the currency index as an average of the normalized currency values.

An additional aspect involves a computerized method performed, using at least one processor executing program instructions on data retrieved from memory, with respect to a focus currency of a focus country, identified from a set of free-trading currencies of countries, and a group of currencies from the set other than the focus currency, wherein the group defines non-focus currencies each corresponding to a non-focus country. The method involves calculating competitive weights for each of the non-focus currencies wherein each weight reflects competition between goods of the focus country and i) goods of each non-focus country in the non-focus country, and ii) goods of each non-focus country in each third-party country of the group, as a percentage of all market trading partners. The method also involves performing a covariance adjustment to the competitive weights of each of the non-focus currencies to obtain final currency weights for each of the non-focus currencies, whereby the final currency weights define a portfolio that allows an investor to take a position on the focus currency without taking a position relative to any particular non-focus currency in the group.

A still further aspect involves an apparatus for generating a currency index. The apparatus includes a currency transaction data processing system including at least one processor and storage, accessible by the processor, the storage including instructions which when executed by the at least one processor will cause the currency transaction data processing system to repeatedly multiply spot rates for a defined group of currencies by covariance adjusted currency weights, obtained from storage and previously calculated from competitive weighting for the defined group of currencies, to generate current weighted currency values for each of the currencies in the defined group, normalize the current weighted currency values to obtain normalized currency values, and generate the currency index as an average of the normalized currency values.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified fashion, example configurations suitable for use with, and containing, an apparatus according to the present claims;

FIG. 2 illustrates, in simplified fashion, a flow diagram for a preliminary phase of the approach;

FIG. 3 illustrates, in simplified fashion, a flow diagram for a trade weight phase of the approach;

FIG. 4 illustrates, in simplified fashion, a flow diagram for the investor flow weight phase of the approach;

FIG. 5 is an example cross-currency covariance matrix for a set of currencies;

FIG. 6 illustrates, in simplified fashion, a flow diagram for a covariance adjusted approach using an approach that involves only the results of the trade weight phase module;

FIG. 7 illustrates, in simplified fashion, a flow diagram for a covariance adjusted approach using an approach that involves only the results of the investor flow weight phase module;

FIG. 8 illustrates, in simplified fashion, a flow diagram for a covariance adjusted approach using the results from both trade weight phase module and investor flow weight phase module;

FIG. 9 illustrates, in simplified fashion, a flow diagram for the covariance adjusted approach with the weighted average values; and

FIG. 10 illustrates, in simplified fashion, a flow diagram for constructing an index based upon the covariance adjusted values.

### DETAILED DESCRIPTION

In simplified overview, our approach is to us a weighted combination of factors that use relevance of competitiveness through bilateral trade, as the Fed does with their indicies, along with using investor portfolio allocations to recognize that some countries may be more important components of the focus country's currency performance than would be indicated by the bilateral trade flows, while also making sure that no currency is overly dominant in a variance/covariance relationship with the focus currency.

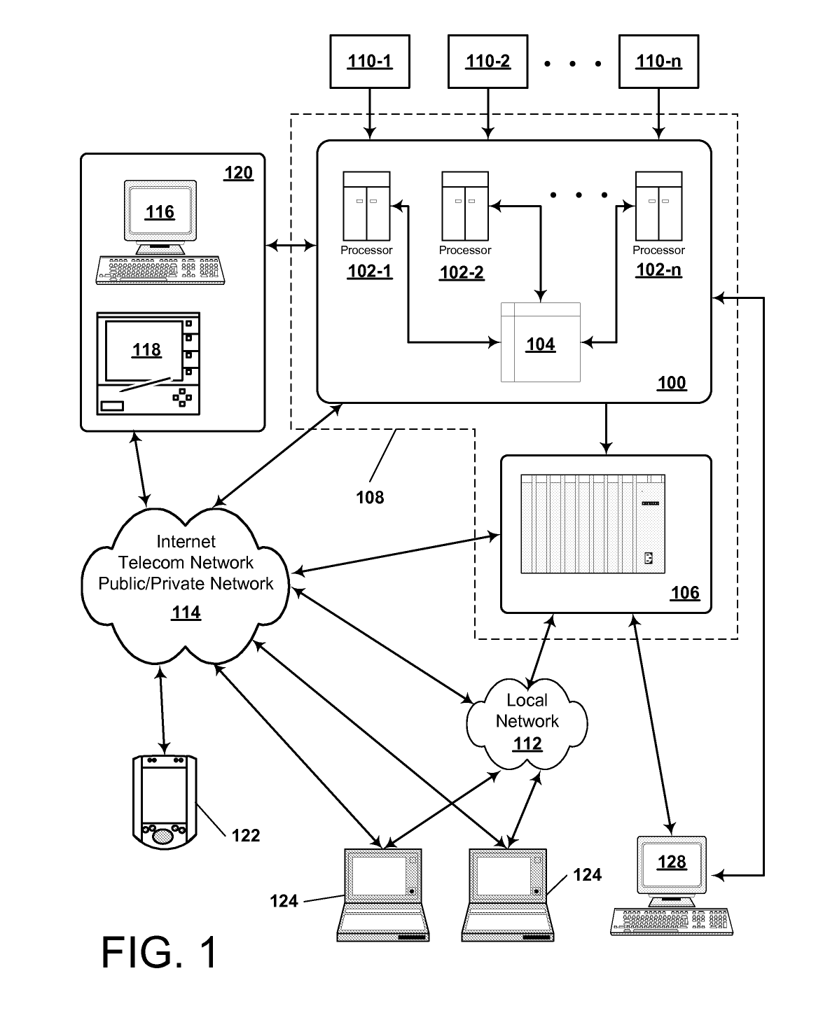

In the above regard, FIG. 1 illustrates, in simplified fashion, example configurations suitable for use with, and containing, an apparatus according to the present claims. Specifically, our approach is implemented as a computerized approach in which we construct a currency analysis processing system (100) made up of at least one, and possibly more, processors (102-1, 102-2, . . . 102-n) and storage (104), accessible by the processor(s) which itself may be made up of various storage devices such as random access memory (“RAM”), read only memory (“ROM”), solid state memory, disk drives, or any other storage device capable of holding data and/or program code to effect the approaches referred to herein.

The currency analysis processing system (100) is configured such that one or more of the processor(s) (102-1, 102-2, . . . 102-n), operating under control of the program code specifying desired program flow, can receive information and access the storage to implement one or more of the variant approaches described in greater detail herein.

Depending upon the particular variant and implementation, the currency analysis processing system (100) can be coupled to, or optionally itself contain, an exchange system (106) such that the currency analysis processing system (100) alone, or in conjunction with the exchange system (106), will function as a currency transaction data processing system (108). The exchange system (106), if not implemented as part of the currency analysis processing system (100) will itself contain processing and storage capability that can be constructed and used in a conventional way an exchange for financial instruments can be constructed so as to enable it to receive bids and offers for financial instruments and match bids and offers for those financial instruments.

Depending upon the particular variant and implementation, the currency analysis processing system (100) and/or the currency transaction data processing system (108) may also be configured to publish an index, constructed as described herein, for receipt and/or viewing by the relevant audience.

In addition, the currency analysis processing system (100) is configured to receive financial data, using known methods, either directly from the data sources or via third-party sources (110-1, 110-2, . . . , 110-n) such as Bloomberg, Haver Analytics, Thomson, etc. The data can include, for example, data from the U.S. Treasury International Capital (“TIC”) system, data from the International Monetary Fund (“IMF”), currency spot pricing information, and national source or other information regarding currencies of, and/or bilateral trade between, the countries of interest.

Depending upon the particular implementation variant and circumstances, the currency analysis processing system (100), the exchange system (106), and/or the currency transaction data processing system (108) can be made accessible to at least one or more of the following via, for example any one or more of, a local network (112) or a more widely accessible network (114) such as the internet, a telecommunications network or some other form of public or private network. In this way, the results of the different variant approaches herein can be made available to, for example, terminals (116) and specialized order entry systems (118) of an exchange or trading floor (120), persons of interest using a wireless handheld device like a smartphone (122), personal computers (124), or to terminals typical for the financial industry (126). Of course, depending upon the particular implementation, a device (128) which could be any of the foregoing types of devices (116, 118, 122, 124) could directly connect to the currency analysis processing system (100), the exchange system (106), and/or the currency transaction data processing system (108), the particular device or mode of connection details being both conventional and unimportant to understanding or use of the variants described herein.

Having described various physical components that can be used to implement or use our variant approaches as a backdrop, details about the various variants of our approaches themselves will now be discussed.

As a preliminary point, it should be noted that, as used herein, the term “country” does not necessarily mean a particular national entity. Rather, “country” can mean a specific national entity or a group of national entities that collectively share a common or regional currency. For example, for purposes of the approaches described herein, the members of the Eurozone, although independent nations, are collectively treated as a “country” herein with respect to the currency the Euro. However, as will become evident, any individual nation participant of the Eurozone can itself be treated as a “country” herein provided that the information needed to perform the calculations of the particular variant are available, despite the use of the same Euro currency by multiple individual nations.

Similarly, a country that has adopted the currency of another nation as its own (“dollarized”), for example, Ecuador which has adopted the U.S. dollar as its official currency will not be precluded from being a “country” for purposes of analysis because the information potentially needed for the variants is not reported only in aggregate, but rather U.S. and Ecuadorean information are each separate and discrete. Conversely, if desired, one could treat the United States and Ecuador collectively as a “country” if the appropriate aggregate data could be obtained or derived.

Advantageously, due to the availability of the necessary information and the fact that their currencies are free-trading, generally all developed country currencies can be eligible for use with the variants of our approach. However, country currencies that have limited liquidity, for example, emerging market currencies, or currencies of countries that are not free-trading, should not generally be used in variants of our approach.

In addition, some variants of our approach advantageously reflect both the relative economic challenge that a country poses to focus country competitiveness and the relative levels of investor-related flows relating to those countries.

A further advantage to the variants of our approach are that weights are covariance adjusted. This has the effect of downplaying close correlations between currencies of different countries, thereby preventing any single currency from dominating index performance due to any such correlation.

Still further, the variants of our approach are constructed in a way that facilitates market replication.

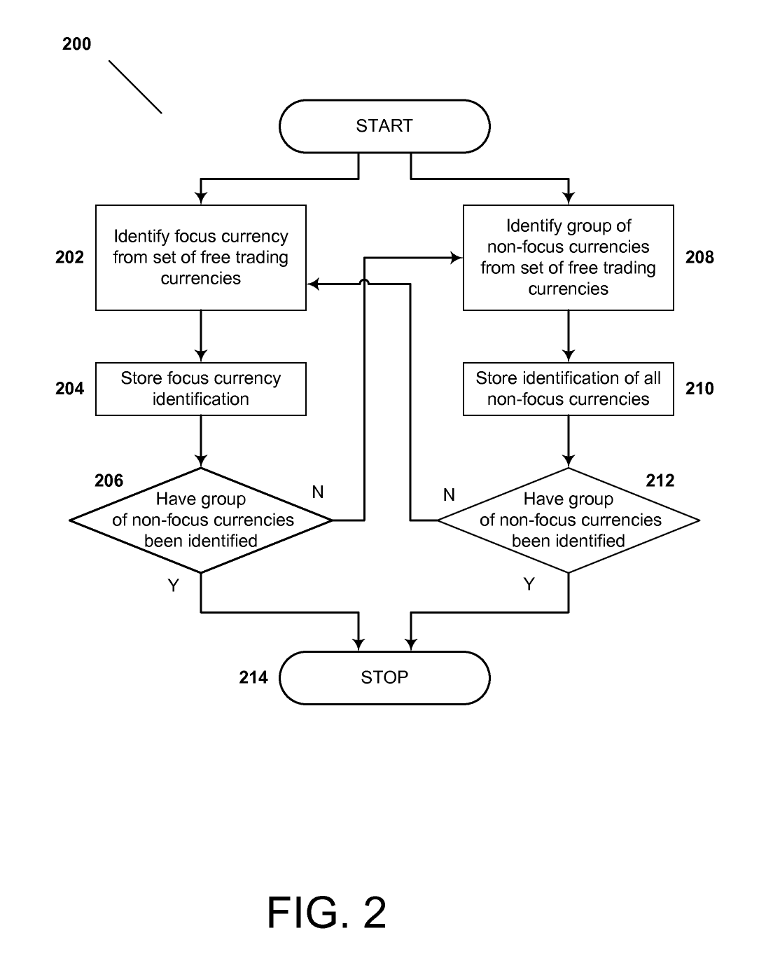

FIG. 2 illustrates, in simplified fashion, a flow diagram for a preliminary phase (200) of the approach. This preliminary phase (200) involves involves two sub-phases, one being the selection of the focus currency, and the other being the selection, from among a set of country currencies, a group of other currencies against which the focus currency performance will be measured, subject to optional further adjustments to be described later. Either or both of these sub-phases can be performed manually or in an automated fashion, for example using the currency analysis processing system (100) of FIG. 1, depending upon the particular implementation involved. In addition, the two sub-phases are wholly independent of each other, other than the fact that the focus currency should also be selected as part of the group that will be the non-focus currencies. This is represented in FIG. 2 by the fact that there are two separate, parallel paths which could be undertaken concurrently, left path first, right path first, or in an overlapping or alternating fashion, the important aspect being that, at the end of the preliminary phase, the focus currency and group of non-focus currencies will be identified.

For ease of explanation, the preliminary phase will be explained assuming the simplest variant, a linear, sequential approach that begins with the left path. Using this approach variant, the preliminary phase begins with identification of the focus currency from among the set of available set of selectable free-trading currencies. (Step 202). Once identified, the focus currency itself or an indicator of that focus currency is stored in the system for later use (Step 204). Then, based upon whether or not a group of non-focus currencies have not been identified (Step 206) either this phase is complete or, as in this example, the phase continues with the identification of a group of currencies from the set, other than the focus currency (Step 208). This is the group of currencies against which the focus currency performance will be measured. Depending upon the particular circumstances, the group may contain as few as two currencies and as many as all of the currencies in the set of available currencies, exclusive of the focus currency. Once (or as) the non-focus currencies have been (are) identified, the non-focus currencies or indicators of those non-focus currencies are stored in the system for later use (Step 210). Since both the focus and non-focus currencies have now been identified, the preliminary phase is complete (Step 214). Had the focus currency not yet been identified however, the phase would have shifted to its selection (Step 202).

As a result of completion of the preliminary phase, the currency analysis processing system (100) can be used for any of several different variants, for example, involving trade weights, investor flow weights or a combination of both.

As will be evident from the description below, the following trade weight calculations and the investor weight calculations are wholly independent of each other. As a result, as just mentioned, one or the other need not be calculated at all depending upon the particular desired variant. Advantageously, this means that the approach can be modularized with the use of different modules resulting in different portfolios or indicies. For example, by selecting different modules as described below any of the following variants are possible: a covariant adjusted competitive weight variant based upon trade weights, a covariant adjusted capital weight variant based upon investor flows, and a covariant adjusted combination incorporating both trade weights and investor flow. Moreover, each of those variants can be further used to develop a portfolio based upon the results obtained using one of the variants, construct an index that is based upon the chosen variant(s), or have a financial instrument that is linked to an index based upon a chosen variant.

### Trade Weight Calculations Module

Calculation of trade weights follows the same basic methodology as the Fed for the Fed's 1998 Trade-Weighted Index. The methodology calculates competitive weights by taking the average of import and export weights for each non-focus country economy as a percentage with respect to the focus country. For example, if the focus country is the U.S., trade competition between the U.S. and its trading partners is analyzed.

On the import side, imports into the U.S. market compete with U.S. domestically produced goods. To proxy the impact of this form of trade competition, data for is obtained for the total imports into the focus country for each of the non-focus country economies. In the case where the focus currency is the U.S. dollar, data is obtained for total imports to the United States for each of the non-focus country economies. Then, a calculation of what percentage of these imports over some specified time period, for example the past ten years, are from the economy “m” of each non-focus country. For purposes of representation each such non-focus economy is denoted by a numeric value of the subscript i. This percentage is used as the bilateral import weight for each economy “i”, (in other words, i=1 through n) according to Equation 1:

wi^{import}=mi/Σmi where i=1, 2, 3, . . . , n, sum over i (1)

The export weighting calculation is made up of two parts because focus country exports are not only competing with local producers in each non-focus country, they are also subject to competition from exports of producers in other third party countries. By way of example continuing with the U.S. as the focus country, if one has selected the United Kingdom (“UK”) as one of the non-focus countries, US exports not only compete with UK producers head-to-head in the UK, but also compete with them in other countries. They both vie for business in, for example, Japan, so a stronger UK currency, the British pound (“GBP”), will not only give US producers an advantage exporting to the UK but it also may abet capturing market share from UK producers in other countries.

Accordingly, the direct export share weight is calculated in a similar manner to the import weight shares. In other words the focus country share of exports to country i (where i=1 to n as above) is calculated according to Equation 2:

ei^{export}=ei/Σei where i=1, 2, 3, . . . , n, sum over i (2)

However, that is only one component of the export calculation. Also, cross market share weight is calculated. This calculation can be performed in any of a number of different procedural ways, the important aspect being the resulting cross market export share values, not the style of mathematical manipulations performed to obtain it. For purposes of illustration, a tabular method is used here. Specifically, a cross-market export share table is created where each cell ei,j is defined as the share of manufactured goods consumed in country j that are produced in country i, where ei,j, represents the share produced domestically. The final export share for each country i, where j is all trading partners and not just those in the group, is then defined according to Equation 3 as:

Ee^{import}=Σei*ei,j where j=1, 2, . . . , 10, sum over j (3)

Continuing the example for the U.S. and UK, and presuming that the other members of the group and their currencies are: Australia (dollar (“AUD”)), Canada (dollar (“CAD”)), Switzerland (franc (“CHF”)), Eurozone (euro (“EUR”)), Japan (yen (“JPY”)), Norway (krone (“NOK”)), New Zealand (dollar (“NZD”)), Sweden (krona (“SEK”)), and all other trading partners denoted by “other”, the export results are calculated and reproduced in Table 1 below.

In Table 1, the first column represents the composition of U.S. exports—i.e., the UK absorbs 5.9% of total US exports. The second column shows the market composition of UK manufacturing output, of which 77.1% is consumed domestically. Note that the percents are rounded and the UK output numbers do not add to 100% because goods directed to the U.S. market are not included, since these are already reflected in the U.S. import share numbers. The third column is the product of the two columns and represents the relative degree to which U.S. producers compete with UK producers in each of these markets. The sum of each of these individual country weights is the overall export weight for the GBP.

TABLE 1

| Group | Share US | UK output | Product of |
|---|---|---|---|
| Currency | Exports | market | Share and Output |
| AUD | 2.20% | 1.10% | 0.02% |
| CAD | 26.60% | 1.10% | 0.29% |
| CHF | 1.70% | 1.80% | 0.03% |
| EUR | 19.60% | 2.60% | 0.51% |
| GBP | 5.90% | 77.10% | 4.55% |
| JPY | 8.30% | 0.20% | 0.02% |
| NOK | 0.30% | 1.10% | 0.00% |
| NZD | 0.30% | 1.10% | 0.00% |
| SEK | 0.60% | 3.50% | 0.02% |
| Other | 34.50% | 0.70% | 0.25% |
| Total | 100.00% | 90.30% | 5.70% |

Once the import trade weights and the export trade weights have been calculated for each non-focus country currency, the competitive weights can be calculated for each currency in the group as the average of the import trade weights and the export trade weights.

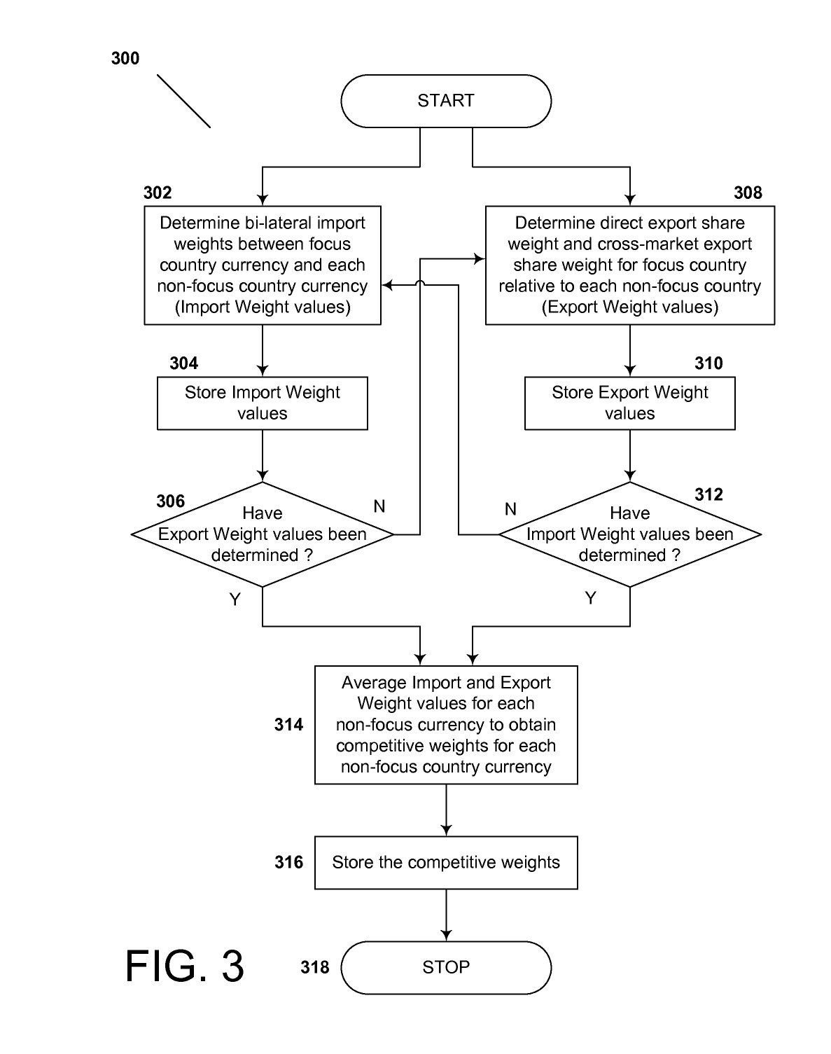

FIG. 3 illustrates, in simplified fashion, a flow diagram for a trade weight phase of the approach. This trade weight phase (300), similar to the preliminary phase (200), partially involves two independent sub-phases, one being the determination of import weights, the other being determination of the export weights. For purposes of simplicity of explanation this is represented in FIG. 3 by the use of two separate, parallel paths which, as with the preliminary phase (200), could be undertaken concurrently, left path first, right path first, or in an overlapping or alternating fashion, the important aspect not being timing, but rather that, at the point where the import and export weight values are averaged, both will have to be available. Also for ease of explanation, this phase will be explained assuming the simplest variant, a linear, sequential approach that begins with the left path.

In accordance with this example variant, the trade weight phase begins with a determination of the bilateral import weights to obtain import weight values (Step 302) for each country i as discussed above. Once (or as) the individual import trade weights have been (are) determined, the those individual import weight values are stored in the system for later use (Step 304). If, at this point, the export values are all also available the process can continue to compute the competitive weights. However, since for this example this is not the case yet (Step 306), the processing moves on to the export weight value determinations. In this sub-phase, the direct export share weights and cross-market share weights are determined for each country and combined (Step 308), for example, as described above, in order to obtain the export weight values. As with the import weight values, once (or as) the individual export trade weights have been (are) determined, those individual export weight values are also stored in the system for later use (Step 310). At this point, both the import weight values and export weight values are all now available (Step 312) so the process can continue to compute the competitive weights. If they were not available, because the export calculations were to all be computed first, the start of that phase (Step 302) would be next.

Once both the import weight values and the export weight values for each non-focus country are available, those values will be averaged for each non-focus country i to generate the competitive weights (Step 314). Again, once (or as) the individual competitive weights have been (are) computed, those individual competitive weight values are stored in the system for later use (Step 316). At this point, the trade weight phase is complete (Step 318).

Having described the analysis that defines the trade weights calculation module, the independently usable investor flow weight calculation module will now be described.

### Investor Flow Weight Calculations Module

Specifically, non-focus country holdings of focus country assets (equities and bonds) for each country are summed with focus country holdings in that country, for example, with the U.S. as the focus country, for Canada as a non-focus country, the Canadian weight would be based on the sum of Canadian holdings of US assets plus US holdings of Canadian assets. The currency weight for each country i is based on the relative size of the summed exposure and is calculated according to Equation 4 as:

wi^{i(TIC or IMF)}=(Assets+Liabilities)i/Σ(Assets+Liabilities)i (4)

where i=1, 2, . . . , n, sum over i, and where (Assets+Liabilities)i is the currency denominated average, for a specified period, of the total exposure.

When the U.S. dollar is the focus currency, TIC System data can be used to proxy the relative importance of a particular currency in the U.S. dollar currency market. However, not all countries whose currency could be part of a group publish cross-border investment allocations. Advantageously however, the IMF does provide global cross-border investment positions for most, if not all, countries in its Coordinated Portfolio Investment Survey. Thus, IMF data can alternatively be used to build capital weights for non U.S. dollar currencies. Moreover, for consistency, it may be desirable to also use IMF data as the U.S. cross-border investment source.

At this point it is also worth noting that, in the case of a regional currency like the euro, additional adjustments can optionally be made. For example, in some variants using the euro as a non-focus currency, it may be desirable to exclude holdings in Luxembourg from the EUR weight because of the distortion introduced due to its role as an offshore banking center.

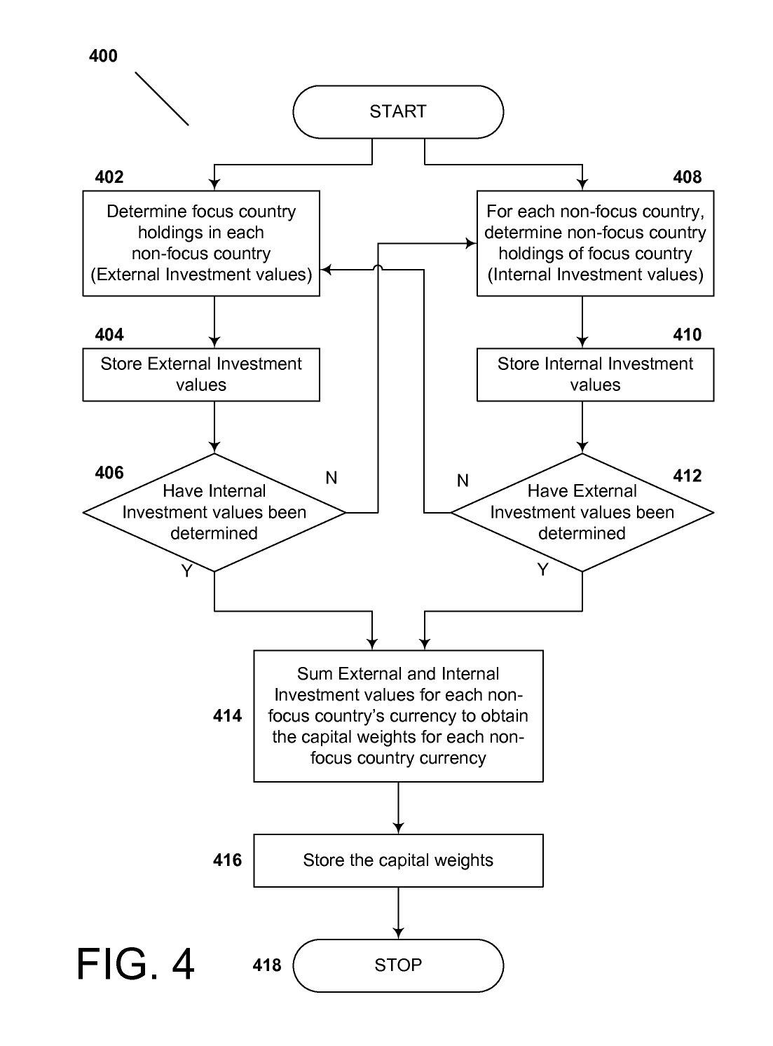

FIG. 4 illustrates, in simplified fashion, a flow diagram for the investor flow weight phase of the approach. This investor flow weight phase (400) is similar to the trade weight phase (300), because, it, partially involves two independent sub-phases; determination of external investment values, and determination of the internal investment values. For purposes of simplicity of explanation, as with FIG. 3, this is represented in FIG. 4 by the use of two separate, parallel paths which could be undertaken concurrently, left path first, right path first, or in an overlapping or alternating fashion, the important aspect again not being timing, but rather that, at the point where the internal and external investment values are summed, both will have to be available. Also for ease of explanation, this phase will similarly be explained assuming the simplest variant, a linear, sequential approach that begins with the left path.

In accordance with this example variant, the investor flow weight phase begins with a determination of the focus country holdings in each non-focus country (Step 402), i.e. the external investment values for each country i as discussed above. Once (or as) the individual external investment values have been (are) determined, the those individual external investment values are stored in the system for later use (Step 404). If, at this point, the internal investment values are all also available the process can continue to compute the capital weights. However, since for this example this is not the case yet (Step 406), the processing moves on to the internal investment value determination (Step 408) described above, in order to obtain the internal investment values. As with the external values, once (or as) the individual external investment values have been (are) determined, those individual external investment values are also stored in the system for later use (Step 410). At this point, both the internal and external investment values are all now available (Step 412) so the process can continue to compute the capital weights. If they were not available, because the internal investment values were to all be determined first, the start of that phase (Step 402) would be next.

Once the external investment values and internal investment values for each non-focus country are available, those values will be summed on a non-focus country basis to generate the capital weights for each non-focus country (Step 414). Again, once (or as) the individual capital weights have been (are) computed, those individual capital weight values are stored for later use (Step 416). The investor flow weight phase is now complete (Step 418).

At this point it is worth noting that, in some cases, the trade weight phase or the investor flow weight phase, the determinations (Steps 302, 308, 402, 408) may simply involve directly obtaining some or all of that information from system storage, because it was previously stored, it may involve directly obtaining some or all of that information from a third-party provider using the system, it may involve directly obtaining some or all of that information from a third-party in a form not directly usable by the system and converting it into a system-usable form, or it may involve detailed analysis and manipulation of certain information. Thus, it should be recognized that neither the form, nor the way that the determination is made in those steps is itself important to understanding the variants. Thus, for some variants or countries i, if the information needed for performing Step 314 or Step 414 is already in the system, Step 302 through Step 312 and/or Step 402 through Step 412 may be dispensed with entirely.

Now either or both of the trade weight phase or the investor flow phase are complete.

### Covariant Adjustment of Weights

As briefly noted above, in some cases, the weight of any particular non-focus currency in the group can have undue influence because it is highly correlated with another currency in the group. As a result, our approach is to minimize the effects by de-weighting high covariance currencies. To do so, covariance between each pair of currencies in the group is calculated using any of numerous known mathematical covariance calculation approaches. Then, an adjustment is performed for all currencies where the covariance is in excess of a specified value. Depending upon the particular variant, the specified value will generally be a covariance in excess of about 60%, and typically in excess of about 65%.

By way of representative example with reference to the group of nine non-focus currencies used above, covariance herein is calculated for each of the nine non-focus currencies against each other and, for purposes of illustration, a cross currency covariance matrix is constructed to house the values for each of those nine non-focus currencies.

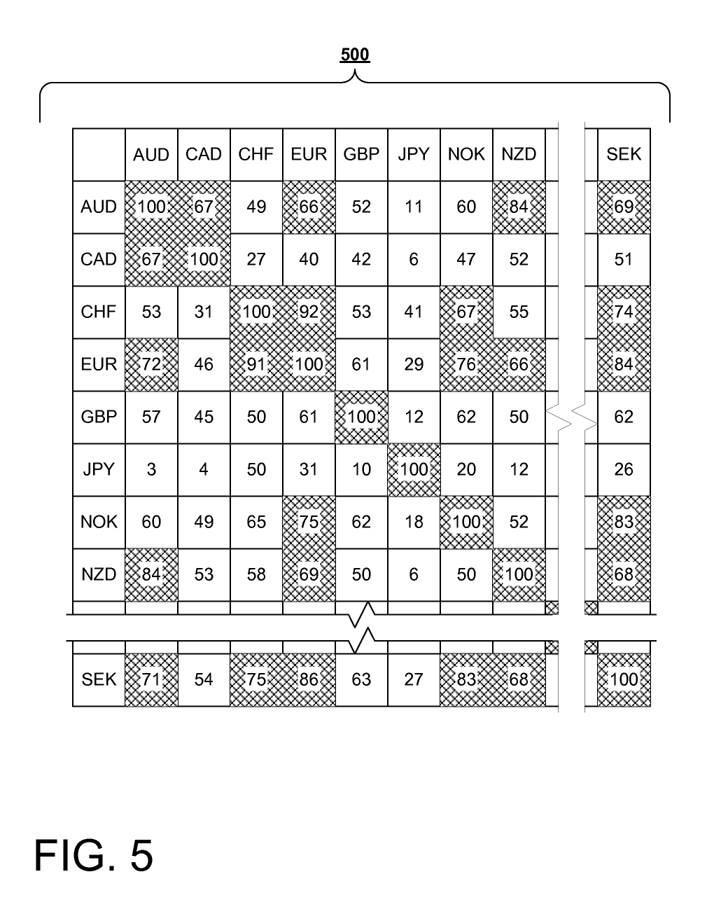

FIG. 5 is an example of a cross-currency covariance matrix (500) for a set of the nine non-focus currencies used above. The matrix is, for purposes of illustration, based upon data for the time period of 1999-2009 and only shows the nine non-focus currencies used above. Depending upon the particular variant, covariance can be calculated and stored for all of the currencies that could be a focus or non-focus currency, some subset of that universe, or only the specific non-focus currencies in the particular group of interest. Again, the particular timing for the calculation of covariance, relative to the other calculations described above, is unimportant provided that the covariance information is available for each non-focus currency in the group at to the time that a covariance adjustment will be made.

As can be seen in the covariance matrix, the upper left to lower right diagonal measures a currency against itself. Consequently, as would be understood, reflects a 100% covariance. This is merely shown for purposes of illustration and would typically not be calculated or stored. The shades boxes have been used to indicate currencies with a covariance threshold in excess of 65%. Turning to the illustrative example's non-focus currencies of FIG. 5, it should be recognized and understood from the matrix (500), the EUR has a covariance in excess of 65% with the other Continental European currency units, and is also highly correlated with the AUD and the NZD. As a consequence, the impact of the EUR is in excess of its weight because it also has influence via its covariance with other currencies. The JPY, by contrast, has very low covariance across the board, so its impact is under-represented relative to the EUR.

In order to address this issue, our approach is to de-weight the currencies with the highest covariance. To do this, in one example variant, we perform a Sharpe-ratio optimization calculation for the currencies in the group and, for a portfolio of the currencies in the group that maximized the Sharpe ratio, we look at the currencies to which the portfolio is skewed. The weights of the currencies to which the portfolio is skewed will be boosted at the expense of the highest covariance currency(ies). The covariance adjustment will be different depending upon the particular implementation, number of currencies in the group and amount of skew. However, an adjustment of about 20% is our rule of thumb. In other words, the lowest covariance (highest percentage optimized Sharps ratio percentages) currencies are each boosted by 20% and the weights of some or all of the other currencies of the group are reduced by an equivalent amount. Again, as a rule of thumb, the reductions will typically be taken from all of the currencies in the group, however, in some variants, it may be desirable to not reduce the weights of all currencies, for example, by leaving unadjusted any currencies whose weight percentage is close to the newly increased percentage currencies once they have been covariance adjusted.

Optionally, a further adjustment can be performed if, after the covariance adjustment re-weighting is performed, there are currencies whose percentages are so low that they will not materially affect performance of the group as a whole, rendering them nominal currencies. In such a case, for simplicity, and depending upon the specific weight percentages, those currencies can be eliminated from the group entirely without further action, or their exposure can be shifted to other currencies in the group and they are dropped. Depending upon the particular variant, the percentage that defines a nominal currency will vary with the number of currencies that make up the group and their respective percentages. However, a rule of thumb is that nominal currencies will have percentages less than about 3%. Currencies whose percentages are about 1% will typically be treated as nominal currencies.

By way of example, if the weight percentage of one of the currencies in a group was 0.2%, and the next higher weight percentage of one or more currencies was 9%, the currency with a weight percentage of 0.2% could simply be dropped and ignored.

Alternatively however, if the weight percentage of a currency in an example group was 1% and the next higher currency weight for a member of the group was 3.3%, simply dropping the 1% currency would not necessarily be desirable. In such a case, one can optionally perform a further adjustment by shifting the exposure of the 1% currency into the currency or currencies of the group with which it has had the highest covariance over some reasonably recent past time period, for example, depending upon the particular variant, 3, 5 or 7 years. Depending upon the particular variant, the exposure can be divided equally among those currencies with which it has had the highest covariance over the period, or it can be apportioned out in some manner, for example, in relative proportion to the covariance percentages of those currencies.

### Weighted Averaged Variants

As noted above, one of our goals is to avoid over-weighting any specific currency. In the case where both investor flows and trade weight are used, this creates the need for a trade-off on weighting between the two. This is best illustrated with reference to Table 2 which shows, for each of the nine currencies used above, the different percentages that result from taking a weighted average of both investor flows and trade weight. Specifically, Table 2 uses weightings ranging from 10% investor flow and 90% trade weight, to 90% investor flow and 10% trade weight. Note that, for purpose of this example, the values in Table 2 are based upon investor flow calculations, as described above, that are based upon TIC data, rather than IMF data.

TABLE 2

| | TIC | Trade | Resulting currency weight | | | | | | | | |
|---|---|---|---|---|---|---|---|---|---|---|---|
| | Wt | Wt | AUD | CAD | CHF | EUR | GBP | JPY | NOK | NZD | SEK |
| #1 | 10% | 90% | 3% | 34% | 2% | 32% | 9% | 16% | 1% | 0% | 2% |
| #2 | 20% | 80% | 3% | 32% | 3% | 32% | 10% | 16% | 1% | 0% | 3% |
| #3 | 30% | 70% | 3% | 29% | 3% | 32% | 11% | 17% | 1% | 0% | 3% |
| #4 | 40% | 60% | 3% | 26% | 4% | 32% | 12% | 17% | 1% | 0% | 4% |
| #5 | 50% | 50% | 3% | 23% | 4% | 33% | 13% | 18% | 1% | 0% | 5% |
| #6 | 60% | 40% | 3% | 21% | 4% | 33% | 14% | 18% | 1% | 0% | 5% |
| #7 | 70% | 30% | 3% | 18% | 5% | 33% | 16% | 19% | 1% | 0% | 6% |
| #8 | 80% | 20% | 3% | 15% | 5% | 33% | 17% | 19% | 1% | 0% | 7% |
| #9 | 90% | 10% | 3% | 12% | 5% | 33% | 18% | 20% | 1% | 0% | 8% |

As shown in Table 2, a low investor flow weight results in under weighting of the Japanese yen and over weighting of the Canadian dollar. Consequently, dependent upon the particular variant, one will have to use the appropriate tradeoff value. We believe that the range will generally be within the range of between from about a 40% investor flow and about 60% trade weight to about 80% investor flow and about 20% trade weight. The selection for a particular variant can be based upon different factors. For example, where the U.S. is the focus currency, it could be based upon a comparison of non-financial flows as reported in the Bank for International Settlements Tri-Annual Survey to total flows as a proxy for the relative importance of trade flows to investor flows yields an overall average of 20% trade flows. Alternatively, it could be based upon a comparison of gross merchandise trade to balance of payments, which would yield an average of just below 40% trade flows. Another alternative could take a midpoint between the two of 30% trade weight as a compromise between the two calculations. Where the focus currency is some other currency, a similar type of analysis can be done.

It should be noted that the above weighted averaging of investor flows and trade flows may still result in over or under weighting of particular currencies due to covariance. As a result, the covariance adjustment will be appropriate in cases where just investor flows are used, just trade flows are used or a weighted average of the two are used.

Table 3 below shows a Sharpe-ratio optimized portfolios of currencies that results from using the weighted average approach according to a weighting of 70% investor flows and 30% trade flows, with each column representing a portfolio for the time periods noted between 1999 and 2009.

TABLE 3

| | 1999-2001 | 2002-2005 | 2006-2008 | 2009 | 1999-2009 |
|---|---|---|---|---|---|
| AUD | 0.00% | 3.00% | 1.00% | 0.00% | 0.00% |
| CAD | 60.00% | 38.00% | 29.00% | 28.00% | 40.00% |
| CHF | 2.00% | 0.00% | 0.00% | 8.00% | 0.00% |
| EUR | 0.00% | 0.00% | 10.00% | 8.00% | 2.00% |
| GBP | 24.00% | 31.00% | 16.00% | 15.00% | 25.00% |
| JPY | 10.00% | 23.00% | 36.00% | 41.00% | 33.00% |
| NOK | 3.00% | 0.00% | 0.00% | 0.00% | 0.00% |
| NZD | 0.00% | 5.00% | 8.00% | 0.00% | 0.00% |
| SEK | 0.00% | 0.00% | 0.00% | 0.00% | 0.00% |

As can be seen from Table 3, within each of the different time periods, the percentages are skewed towards the low covariance CAD, GBP and JPY. As a result, it would be desirable to increase the weights of these currencies at the expense of the others, for illustrative example, using a 20% adjustment as described above.

With the above in mind, the remaining calculations for different variants can now be presented.

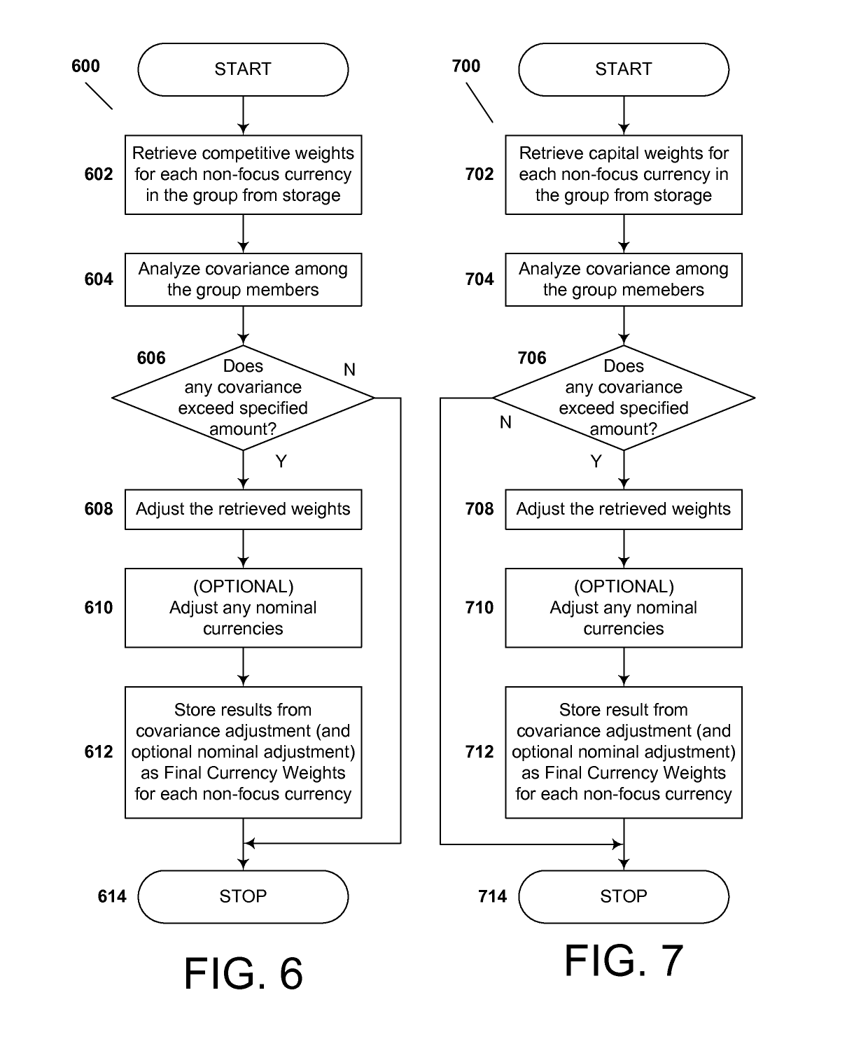

FIG. 6 illustrates, in simplified fashion, a flow diagram for a covariance adjusted approach using an approach that involves only the results of the trade weight phase module.

As shown in FIG. 6, the process (600) begins with the retrieval from storage of the previously calculated competitive weights (Step 602). Next, covariance among the members of the group relative to each other is analyzed (Step 604). A determination is made as to whether the covariance between any two members of the non-focus currencies in the group exceeds a specified percentage (Step 604). If the cross-currency covariance exceeds the specified percentage, the retrieved trade weights are adjusted (Step 608). Optionally, if following the adjustment, any of the currencies are nominal currencies, they can be dropped or adjusted for (Step 610). Finally, the adjusted amounts for the non-focus currencies are stored (Step 612) and the process is complete (Step 614). If the cross-currency covariance among all of the members of the group was below the specified amount, then no covariance or nominal currency adjustments would need to be made and the process would be complete (Step 614).

FIG. 7 illustrates, in simplified fashion, a flow diagram for a covariance adjusted approach that involves only the results of the investor flow weight phase module. The process is the same as for the trade weights, except that the investor flow weight values would be used.

As shown in FIG. 7, the process (700) begins with the retrieval from storage of the previously calculated competitive weights (Step 702). Next, covariance among the members of the group relative to each other is analyzed (Step 704). A determination is made as to whether the covariance between any two members of the non-focus currencies in the group exceeds a specified percentage (Step 704). If the cross-currency covariance exceeds the specified percentage, the retrieved trade weights are adjusted (Step 708). Optionally, if following the adjustment, any of the currencies are nominal currencies, they can be dropped or adjusted for (Step 710). Finally, the adjusted amounts for the non-focus currencies are stored (Step 712) and the process is complete (Step 714). If the cross-currency covariance among all of the members of the group was below the specified amount, then no covariance or nominal currency adjustments would need to be made and the process would be complete (Step 714).

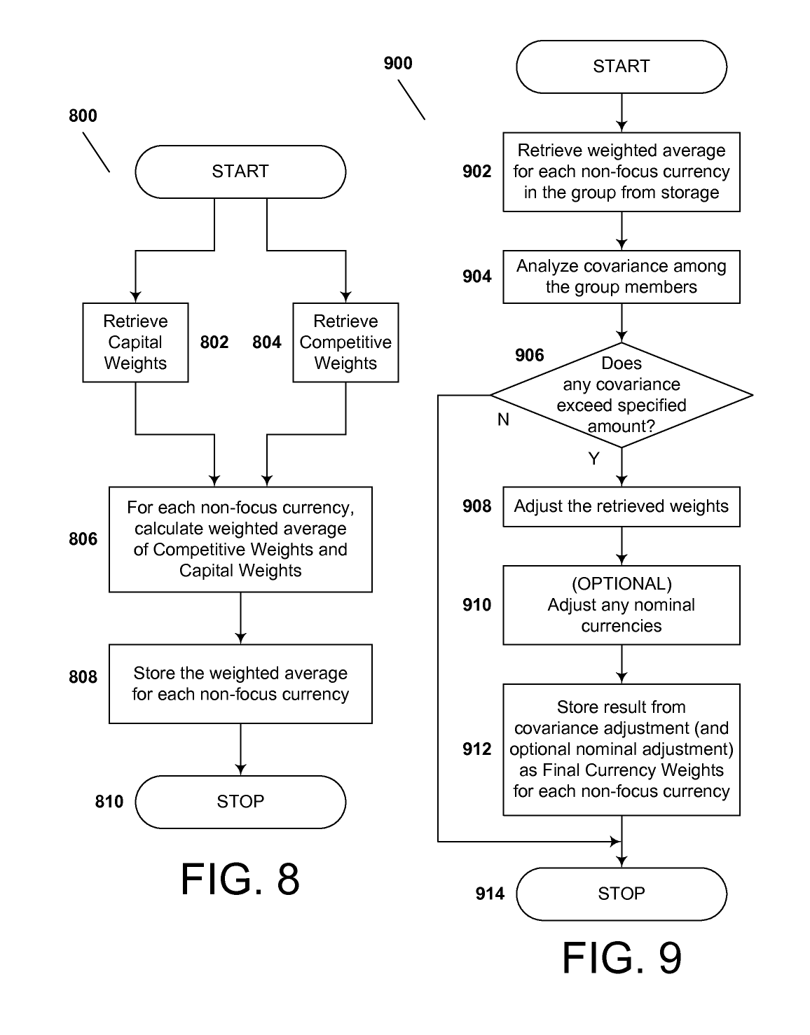

In the case where both the trade weights and investor flows are to be used, via the weighted average discussed above, the approach is somewhat similar to that of FIG. 6 and FIG. 7. FIG. 8 illustrates, in simplified fashion, a flow diagram for a covariance adjusted approach using the results from both trade weight and investor flow weight phase modules. The process begins with the retrieval, in any order, of the capital weights (Step 802) and competitive weights (Step 804) for each of the non-focus currencies. Next the weighted average of the capital weights and competitive weights for each of the focus currencies calculated (Step 806).

At this point it should be noted that, depending upon the particular variant, the actual weighting of the capital weights and/or the competitive weights could have alternatively been calculated as part of the processes of FIG. 3 and/or FIG. 4. For example, if it was known at the time of the calculations described in connection with FIG. 3 and/or FIG. 4, that a 70% weighting was to be given to the capital weights, the values could have been adjusted such that the stored capital weights (Step 416) were 70% of their actual values and the stored competitive weights (Step 316) were 30% of their actual values. If this was the case, then the calculation of the weighted average (Step 806) would be a simple average of the capital weights and the competitive weights. Finally, the weighted average values for the non-focus currencies will be stored (Step 808). Once the weighted average has been calculated for all of the non-focus currencies, the process is complete (Step 810).

Again, it bears repeating that, as with the other calculations above, this could be done on a currency by currency basis (i.e. calculate, store, calculate store, etc.) or it could be done such that more than one currency is handled before any are stored. Again, the important aspect of this portion of the process is that, at the end of the process (Step 810), the weighted average of all of the non-focus currencies are available. The specific ordering of the calculations for any given currency, and the storage order, is irrelevant.

At this point, the combined (i.e. weighted average) values can be covariance adjusted.

FIG. 9 illustrates, in simplified fashion, a flow diagram for the covariance adjusted approach with the weighted average values. The process is basically the same as the variants of FIGS. 6 and 7, where, respectively, only the competitive weights or capital weights were used.

As shown in FIG. 9, the process (900) begins with retrieval from storage of the weighted average values for each of the non-focus currencies (Step 902). Next, covariance among the members of the group relative to each other is analyzed (Step 904). A determination is made as to whether the covariance between any two members of the non-focus currencies in the group exceeds a specified percentage (Step 904). If the cross-currency covariance exceeds the specified percentage, the retrieved trade weights are adjusted (Step 908). Optionally, if after the adjustment, any of the currencies are nominal currencies, they can be dropped or adjusted for (Step 910). Finally, the adjusted amounts for the non-focus currencies are stored (Step 912) and the process is complete (Step 914). If the cross-currency covariance among all of the members of the group was below the specified amount, then no covariance or nominal currency adjustments would need to be made and the process would be complete (Step 914).

### Portfolio, Financial Instrument and Index Construction

Following the processes described in FIGS. 6 thru 9, the resulting weights will define a portfolio of the respective currencies. Holding the currencies indicated according to the weight percentages for each non-focus currency will thereby allow an investor to take a position with respect to the non-focus currency relative to the group as a whole, i.e. the non-focus currency's general market performance relative to the market defined by the group of non-focus currencies.

Tables 4, 5 and 6 illustrate results of the above calculations for three different focus currencies, the U.K. pound, The Japanese yen and the Euro, involving a 70%/30% weighted average of the capital weights and the competitive weights. Note that for the situations depicted in Tables 4 through 6, IMF data was used. In each of the tables, the first column contains the non-focus currencies that were part of the particular group, the second column contains the capital weights calculated as above. The third column contains the competitive weights calculated as above. The fourth column contains the result of taking a weighted average of 70% capital weights and 30% competitive weights. The fifth column contains the results of covariance adjusting the values from the fourth column. The sixth column contains the final weightings that define the relevant portfolio.

With respect to the tables it should be noted that, after covariance adjustment, the New Zealand dollar had a weighting of only 0.3%. As a result, it was considered a nominal currency and its exposure was added to the currency with the highest covariance to it, in this case the Australian dollar.

TABLE 4
U.K. Pound (GBP)

| | | | 70/30 | Covariance | |
|---|---|---|---|---|---|
| | Capital | Competitive | Weighted | Adjusted | Final |
| | Weight | Weight | Average | value | Weighting |
| AUD | 2.40% | 1.70% | 2.20% | 2.60% | 2.60% |
| CAD | 1.90% | 2.90% | 2.20% | 3.20% | 3.20% |
| CHF | 2.70% | 1.70% | 2.40% | 3.00% | 3.00% |
| EUR | 42.20% | 51.70% | 45.00% | 42.70% | 42.70% |
| GBP | 7.90% | 9.80% | 8.50% | 7.20% | 7.20% |
| NOK | 1.50% | 1.10% | 1.40% | 3.10% | 3.10% |
| NZD | 0.20% | 0.30% | 0.20% | 2.40% | 2.40% |
| SEK | 2.00% | 1.90% | 1.90% | 1.60% | 1.60% |
| USD | 39.30% | 28.80% | 36.10% | 34.20% | 34.20% |

TABLE 5
Japanese Yen (JPY)

| | | | 70/30 | | |
|---|---|---|---|---|---|
| | Capital | Competitive | Weighted | Covariance | Final |
| | Weight | Weight | Average | Adjusted value | Weighting |
| AUD | 2.80% | 5.20% | 3.50% | 2.80% | 3.10% |
| CAD | 3.00% | 4.10% | 3.30% | 2.70% | 2.70% |
| CHF | 1.30% | 1.50% | 1.40% | 10.30% | 10.30% |
| EUR | 27.70% | 6.40% | 21.30% | 15.20% | 15.20% |
| GBP | 12.50% | 34.30% | 19.00% | 15.20% | 15.20% |
| NOK | 1.70% | 0.80% | 1.50% | 1.20% | 1.20% |
| NZD | 0.20% | 0.70% | 0.40% | 0.30% | 0.00% |
| SEK | 1.50% | 1.20% | 1.40% | 1.10% | 1.10% |
| USD | 49.20% | 45.80% | 48.20% | 49.30% | 49.30% |

TABLE 6
Eurozone Euro (EUR)

| | | | 70/30 | | |
|---|---|---|---|---|---|
| | Capital | Competitive | Weighted | Covariance | Final |
| | Weight | Weight | Average | Adjusted value | Weighting |
| AUD | 2.00% | 1.70% | 2.20% | 2.90% | 3.20% |
| CAD | 2.30% | 2.90% | 2.20% | 2.10% | 2.10% |
| CHF | 6.40% | 1.70% | 2.40% | 12.20% | 12.20% |
| GBP | 29.60% | 51.70% | 45.00% | 37.30% | 37.30% |
| JPY | 12.40% | 9.80% | 8.50% | 8.50% | 8.50% |
| NOK | 3.20% | 1.10% | 1.40% | 1.40% | 1.40% |
| NZD | 0.10% | 0.30% | 0.20% | 0.20% | 0.00% |
| SEK | 3.50% | 1.90% | 1.90% | 1.90% | 1.90% |
| USD | 40.60% | 28.80% | 36.10% | 30.00% | 30.00% |

Advantageously as a result, once the calculations are complete, additional steps can be taken. For example, an investor or institution can build a portfolio of the currencies according to the resultant weightings. Hedging strategies can be employed involving, or relative to, the portfolio using known techniques. Alternatively, the portfolio can be part of, or form, a managed account. Still further, financial instruments, including exchange traded funds, exchange traded notes, and various other types of derivative instruments can be constructed in a known manner to mirror, or that are linked to the performance of, the portfolio.

In addition, advantageously, an index can be constructed based upon the portfolio that will generally reflect the performance of the .focus currency relative to the group of non-focus currencies taken as a whole.

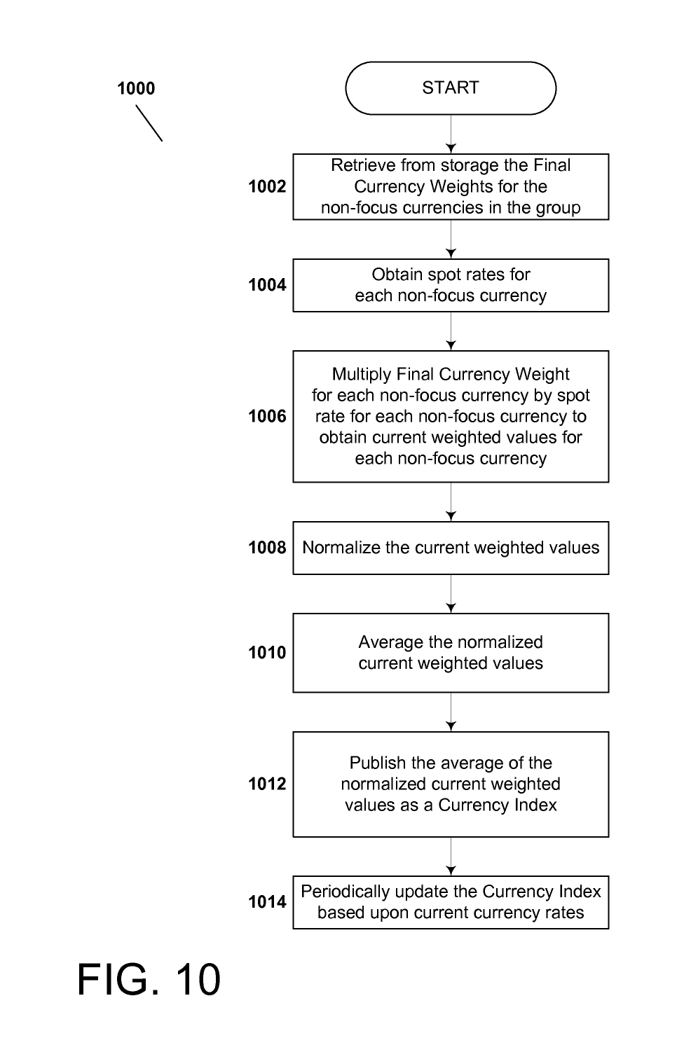

FIG. 10 illustrates, in simplified fashion, a flow diagram (1000) for constructing an index based upon the covariance adjusted values. The process begins with retrieval of the final currency weights for the members of the group (i.e. the resultant non-focus currency values from the processes of FIG. 6. FIG. 7 or FIG. 9) (Step 1002). Next, spot rates are obtained for each of the non-focus currencies in the group (Step 1004), for example, directly from a currency exchange or indirectly via a third party provider. Note that, as used herein, the “spot” rate is intended to encompass not only the then-actual instantaneous exchange value, but could alternatively be a forward price, an average price for a specified time period or some other price, provided that whatever is used for one non-focus currency is used by all. Next, the final currency weight for each non-focus currency in the group is multiplied by its corresponding spot rate (Step 1006).

Note that it is unlikely that the product of the weights and spot rates will result in magnitudes of each of the currencies (as absolute values) relative to each other that are the same. This is shown, for example, in the cross-currency conversion chart of Table 7 below for the listed currencies. Multiplying by the weighting percentages is unlikely to bring them into a common scale such that they can be combined without the absolute values improperly skewing the result.

TABLE 7

| | GBP | CAD | EUR | JPY | CHF | USD | AUD | SEK |
|---|---|---|---|---|---|---|---|---|
| GBP | 1.000 | 0.619 | 0.875 | 0.008 | 0.653 | 0.626 | 0.620 | 0.095 |
| CAD | 1.617 | 1.000 | 1.414 | 0.012 | 1.055 | 1.011 | 1.002 | 0.153 |
| EUR | 1.144 | 0.709 | 1.000 | 0.009 | 0.746 | 0.716 | 0.710 | 0.108 |
| JPY | 130.317 | 80.683 | 113.888 | 1.000 | 84.989 | 81.488 | 80.784 | 12.324 |
| CHF | 1.534 | 0.950 | 1.341 | 0.012 | 1.000 | 0.960 | 0.952 | 0.145 |
| USD | 1.600 | 0.990 | 1.398 | 0.012 | 1.043 | 1.000 | 0.992 | 0.151 |
| AUD | 1.615 | 1.000 | 1.412 | 0.012 | 1.053 | 1.010 | 1.000 | 0.153 |
| SEK | 10.610 | 6.568 | 9.265 | 0.082 | 6.920 | 6.633 | 6.577 | 1.000 |

As a result, the values for each currency will need to be normalized so that they can be combined into an index. There are numerous known approaches in mathematics and economics to accomplish this and the particular computation method will depend upon whether a return index, an absolute performance index or spot index is the intended end result. One simple example illustrative way is to establish a base date and calculate the percentage deviation between the date of concern and the base date. Another way is to treat the base date value for all of the members of the group as a fixed number, for example “100”, and scale everything subsequently by dividing the value on the date of concern by the value on the base date. For example, if on the base date the value of one of the non-focus currencies relative to the focus currency is 1.5 and the value of another of the non-focus currencies relative to the focus currency is 1350, the base value of 100 would be obtained, for the first non-focus currency by multiplying it by 66.6667, and for the second non-focus currency by multiplying it by 0.0740. Thus, if on a subsequent date the first non-focus currency is now 1.375 and the second non-focus currency is 1500, their respective values for calculating the index would be calculated as (1.375×66.6667)=91.6667 and (1500×0.740)=111.1111.

In any event, the product of the spot prices and weightings are normalized using any appropriate method (Step 1008). Then the normalized values are then averaged to obtain the currency index for those currencies on a focus currency basis (Step 1010). In the case of a group made up solely of the immediately preceding two non-focus currencies, the index would be equal to (91.6667+111.1111)/2, giving an index value of 101.3889.

At this point it is worth noting that the Fed's 1978 and 1998 indicies are both geometric averages. Our approach, as can be seen from the above, generally uses an arithmetic average. With an arithmetic average, currency declines will carry less weight than equivalent increases. A geometric average avoids this bias but such a bias is trivially small unless the movements of the currencies are very substantial over time. Thus, if currencies of hyper-inflating economies with exponential annual growth rates are part of a group, a geometric average should be used. In contrast, where the currencies included in the group have a relatively stable history, there should be little difference in the two averages, so an arithmetic average can be used which advantageously makes the index easier to replicate in the market.

At this point, the currency index can be “published” (i.e. disseminated for viewing and/or use by the relevant public) (Step 1012). Depending upon the particular variant, the index will thereafter be updated, on some periodic basis based upon the then-current rates for the currencies in the group (Step 1014) which could occur, for example, on a continuous basis (i.e. whenever any value changes) like the major equity indicies, it could be updated on a specific scheduled basis, such as every minute or hourly. It could be updated daily, like the Net Asset Valuation (NAV) calculations of mutual fund values, or according to some other appropriate chosen scheme.

Again, once an index is created, financial instruments can be created that are based upon, or linked to the performance of, the index.

It should be understood that this description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. A computerized method performed, using at least one processor executing program instructions on data retrieved from memory, with respect to a focus currency of a focus country, identified from a set of free-trading currencies of countries, and a group of currencies from the set other than the focus currency, wherein the group defines non-focus currencies each corresponding to a non-focus country, the method comprising:
calculating, using the at least one processor, competitive weights for each of the non-focus currencies, wherein each weight reflects competition between goods of the focus country and
i) goods of each non-focus country in the non-focus country, and
ii) goods of each non-focus country in each third-party country of the group, as a percentage of all market trading partners;
calculating, using the at least one processor, capital weights for each of the non-focus currencies such that each capital weight reflects investment holdings of the focus country in non-focus countries of the group and investment holdings of non-focus countries of the group in the focus country as a percentage of total holdings;
calculating, using the at least one processor, currency weights as a weighted average of the competitive weights and the capital weights according to a specified weighting bias;
performing, using the at least one processor, a covariance adjustment to the currency weights of each of the non-focus currencies to obtain final currency weights for each of the non-focus currencies;
whereby the final currency weights define a portfolio that allows an investor to take a position on the focus currency without taking a position relative to any particular non-focus currency in the group.

2. The method of claim 1, wherein:
United States dollars are the focus currency.

3. The method of claim 1, wherein:
Euros are the focus currency.

4. The method of claim 1, wherein:
the non-focus currencies include at least one of:
Australian dollars, Canadian dollars, Eurozone country euros, Japanese yen, New Zealand dollars, Swiss francs, British pounds, Norwegian krone and Swedish krona.

5. The method of claim 1, further comprising:
repeatedly receiving spot prices for each of the non-focus currencies;
calculating, using the at least one processor, a current weighted value for each of the non-focus currencies by multiplying the final currency weights of each of the non-focus currencies by the spot prices of each of the non-focus currencies;
normalizing the current weighted values, using the at least one processor, to obtain normalized current weighted values; and
generating a focus currency index as an average of the normalized current weighted values.

6. The method of claim 5, wherein the generating comprises:
calculating, using the at least one processor, an arithmetic average of the normalized current weighted values.

7. The method of claim 5, wherein the generating comprises:
calculating, using the at least one processor, a geometric average of the normalized current weighted values.

8. The method of claim 5, further comprising:
creating a financial instrument that is linked to performance of the focus currency index.

9. The method of claim 5, further comprising:
creating a financial instrument having a composition that substantially corresponds to a composition of the focus currency index.

10. The method of claim 5, further comprising:
publishing the focus currency index.

11. The method of claim 5, further comprising:
using the focus currency index as a benchmark for currency investment.

12. The method of claim 5, further comprising:
generating, using the at least one processor, a covariance matrix for the non-focus currencies.

13. The method of claim 12, wherein the covariance adjustment comprises:
de-weighting any non-focus currency that has a covariance with another non-focus currency in excess of a specified percentage.

14. The method of claim 13, wherein the specified percentage is about 60%.

15. The method of claim 13, wherein the specified percentage is about 65%.

16. The method of claim 13, wherein the performing the covariance adjustment comprises:
determining if any non-focus currencies are nominal currencies because at least one of the final currency weights for at least one of the non-focus currencies is less than about 1%; and
for each nominal currency, rolling exposure for the nominal currency into the specific non-focus currency that has a highest covariance with the nominal currency.

17. The method of claim 12, wherein performing the covariance adjustment comprises:
eliminating any non-focus currencies having interim currency weights that are less than about a 1% weighting.

18. The method of claim 1, wherein:
the specified weighting bias comprises a weighting within a range from between about 60% the competitive weights and about 40% the capital weights to about 20% the competitive weights and about 80% the capital weights.

19. The method of claim 18, wherein:
the weighting is about 30% the competitive weights and about 70% the capital weights.

20. The method of claim 18, wherein:
the weighting is less than 50% the competitive weights and more than 50% the capital weights.

21. The method of claim 1, further comprising:
fixing the competitive weights for each of the non-focus currencies and the capital weights for each of the non-focus currencies for a period of time; and
following passage of the period of time, calculating, using the at least one processor,
new competitive weights for each of the non-focus currencies for use as the competitive weights, and
new capital weights for each of the non-focus currencies for use as the capital weights.

22. A method comprising:
a) specifying a focus currency from among a set of free-trading currencies of countries, and a group of currencies other than the focus currency from among the set;
b) determining, using at least one programmed processor
i) for each of the currencies in the group relative to the focus currency, an import trade weight value as a function of total imports into the country of the focus currency that comes from each of the countries in the group within a specified period,
ii) for each of the currencies in the group relative to the focus currency, an export trade weight value as a function of
I) focus country share of exports to each country in the group; and
II) manufacturing that is consumed within each country in the group,
iii) for each of the currencies in the group, total trade weight values as a function of the import trade weight values and the export trade weight values, and
c) storing the total trade weight values in memory accessible to the programmed processor;
d) determining, using the at least one programmed processor
i) investor external flow weight values as a function of the focus country holdings of investments of each country in the group,
ii) investor internal flow weight values as a function of each country in the group's holdings of focus country investments, and
iii) total investor flow weight values as a function of the investor external flow weight values and the investor internal flow weight values, and
e) storing the total investor flow weight values in the memory;
f) for each of the currencies in the group, calculating, using the at least one programmed processor, unadjusted currency weight values as a combination of the stored total trade weight values and the stored total investor flow weight values; and
g) modifying, using the at least one programmed processor, the unadjusted currency weight values based upon a covariance adjustment calculation to obtain a covariance adjusted, final currency weighted investable portfolio of currencies.

23. The method of claim 22, further comprising:
creating a financial instrument that is linked to performance of the covariance adjusted, final currency weighted investable portfolio of currencies.

24. The method of claim 22, further comprising:
creating a financial instrument having a composition that substantially corresponds to the covariance adjusted, final currency weighted investable portfolio of currencies.

25. The method of claim 22, further comprising:
generating a currency index for the covariance adjusted, final currency weighted investable portfolio of currencies; and
publishing the currency index.

26. An apparatus for generating a currency index, the apparatus comprising:
a currency transaction data processing system including at least one processor and storage, accessible by the processor, the storage including instructions which when executed by the at least one processor will cause the system to repeatedly:
multiply spot rates for a defined group of currencies by covariance adjusted currency weights calculated for the defined group of currencies, obtained from storage, to obtain current weighted currency values for each of the currencies in the defined group;
normalize the current weighted currency values to obtain normalized currency values; and
generate the currency index as an average of the normalized currency values.

27. The apparatus of claim 26, wherein:
the covariance adjusted currency weights obtained from the storage resulted from analysis performed in the currency transaction data processing system which calculated a weighted combination of trade weights and investor flows for the defined group of currencies relative to a focus currency and that have been modified to account for covariance among the currencies of the defined group.

28. A computerized method performed, using at least one processor executing program instructions on data retrieved from memory, with respect to a focus currency of a focus country, identified from a set of free-trading currencies of countries, and a group of currencies from the set other than the focus currency, wherein the group defines non-focus currencies each corresponding to a non-focus country, the method comprising:
calculating, using the at least one processor, capital weights for each of the non-focus currencies such that each capital weight reflects investment holdings of the focus country in non-focus countries of the group and investment holdings of non-focus countries of the group in the focus country as a percentage of total holdings;
performing, using the at least one processor, a covariance adjustment to the capital weights of each of the non-focus currencies to obtain final currency weights for each of the non-focus currencies;
whereby the final currency weights define a portfolio that allows an investor to take a position on the focus currency without taking a position relative to any particular non-focus currency in the group.

29. The method of claim 28, wherein the focus currency is one of:
United States Dollars, Japanese Yen or Euros.

30. The method of claim 28, wherein:
the non-focus currencies include at least one of:
Euros, Australian dollars, Canadian dollars, Japanese yen, New Zealand dollars, Swiss francs, British pounds, Norwegian krone and Swedish krona.

31. The method of claim 28, further comprising:
repeatedly receiving spot prices for each of the non-focus currencies;
calculating, using the at least one processor, a current weighted value for each of the non-focus currencies by multiplying the final currency weights of each of the non-focus currencies by the spot prices of each of the non-focus currencies;
normalizing the current weighted values, using the at least one processor, to obtain normalized current weighted values; and
generating a focus currency index as an average of the normalized current weighted values.

32. The method of claim 31, wherein the generating comprises:
calculating, using the at least one processor, an arithmetic average of the normalized current weighted values.

33. The method of claim 31, wherein the generating comprises:
calculating, using the at least one processor, a geometric average of the normalized current weighted values.

34. The method of claim 31, further comprising:
creating a financial instrument that is linked to performance of the focus currency index.

35. The method of claim 31, further comprising:
creating a financial instrument having a composition that substantially corresponds to a composition of the focus currency index.

36. The method of claim 31, further comprising:
publishing the focus currency index.

37. The method of claim 31, further comprising:
using the focus currency index as a benchmark for currency investment.

38. The method of claim 31, wherein the performing the covariance adjustment comprises:
generating, using the at least one processor, a covariance matrix for the non-focus currencies.

39. The method of claim 38, wherein the covariance adjustment comprises:
de-weighting any non-focus currency that has about a 65% or more covariance with another non-focus currency.

40. The method of claim 39, wherein the performing the covariance adjustment comprises:
determining if any non-focus currencies are nominal currencies because at least one of the final currency weights for at least one of the non-focus currencies is less than about 1%; and
for each nominal currency, rolling exposure for the nominal currency into the specific non-focus currency that has a highest covariance with the nominal currency.

41. The method of claim 38, wherein performing the covariance adjustment comprises:
eliminating any non-focus currencies having interim currency weights that are less than about a 1% weighting.

42. The method of claim 28, further comprising:
fixing the capital weights for each of the non-focus currencies for a period of time; and
following passage of the period of time, calculating, using the at least one processor, new capital weights for each of the non-focus currencies for use as the capital weights.

43. An apparatus for generating a currency index, the apparatus comprising:
a currency transaction data processing system including at least one processor and storage, accessible by the processor, the storage including instructions which when executed by the at least one processor will cause the currency transaction data processing system to repeatedly:
multiply spot rates for a defined group of currencies by covariance adjusted currency weights, obtained from storage and previously calculated from capital weighting for the defined group of currencies, to generate current weighted currency values for each of the currencies in the defined group;
normalize the current weighted currency values to obtain normalized currency values; and
generate the currency index as an average of the normalized currency values.

44. The apparatus of claim 43, wherein the currency transaction data processing system further comprises:
an exchange system configured to
i) receive bids and offers for a financial instrument linked to the currency index; and
ii) match the received bids and offers for the financial instrument.

45. A computerized method performed, using at least one processor executing program instructions on data retrieved from memory, with respect to a focus currency of a focus country, identified from a set of free-trading currencies of countries, and a group of currencies from the set other than the focus currency, wherein the group defines non-focus currencies each corresponding to a non-focus country, the method comprising:
calculating, using the at least one processor, competitive weights for each of the non-focus currencies wherein each weight reflects competition between goods of the focus country and
i) goods of each non-focus country in the non-focus country, and
ii) goods of each non-focus country in each third-party country of the group, as a percentage of all market trading partners;
performing, using the at least one processor, a covariance adjustment to the competitive weights of each of the non-focus currencies to obtain final currency weights for each of the non-focus currencies;
whereby the final currency weights define a portfolio that allows an investor to take a position on the focus currency without taking a position relative to any particular non-focus currency in the group.

46. The method of claim 45, wherein the focus currency is one of:
United States Dollars, Japanese Yen or Euros.

47. The method of claim 45, wherein the non-focus currencies include at least one of:
Euros, Australian dollars, Canadian dollars, Japanese yen, New Zealand dollars, Swiss francs, British pounds, Norwegian krone and Swedish krona.

48. The method of claim 45, further comprising:
repeatedly receiving spot prices for each of the non-focus currencies;
calculating, using the at least one processor, a current weighted value for each of the non-focus currencies by multiplying the final currency weights of each of the non-focus currencies by the spot prices of each of the non-focus currencies;
normalizing the current weighted values, using the at least one processor, to obtain normalized current weighted values; and
generating a focus currency index as an average of the normalized current weighted values.

49. The method of claim 48, wherein the generating comprises:
calculating, using the at least one processor, an arithmetic average of the normalized current weighted values.

50. The method of claim 48, wherein the generating comprises:
calculating, using the at least one processor, a geometric average of the normalized current weighted values.

51. The method of claim 48, further comprising:
creating a financial instrument that is linked to performance of the focus currency index.

52. The method of claim 48, further comprising:
creating a financial instrument having a composition that substantially corresponds to a composition of the focus currency index.

53. The method of claim 48, further comprising:
publishing the focus currency index.

54. The method of claim 48, further comprising:
using the focus currency index as a benchmark for currency investment.

55. The method of claim 48, wherein the performing the covariance adjustment comprises:
generating, using the at least one processor, a covariance matrix for the non-focus currencies.

56. The method of claim 55, wherein the covariance adjustment comprises:
de-weighting any non-focus currency that has about a 65% or more covariance with another non-focus currency.

57. The method of claim 56, wherein the performing the covariance adjustment comprises:
determining if any non-focus currencies are nominal currencies because at least one of the final currency weights for at least one of the non-focus currencies is less than about 1%; and
for each nominal currency, rolling exposure for the nominal currency into the specific non-focus currency that has a highest covariance with the nominal currency.

58. The method of claim 55, wherein performing the covariance adjustment comprises:
eliminating any non-focus currencies having interim currency weights that are less than about a 1% weighting.

59. The method of claim 45, further comprising:
fixing the competitive weights for each of the non-focus currencies for a period of time; and
following passage of the period of time, calculating, using the at least one processor,
new competitive weights for each of the non-focus currencies for use as the competitive weights.

60. An apparatus for generating a currency index, the apparatus comprising:
a currency transaction data processing system including at least one processor and storage, accessible by the processor, the storage including instructions which when executed by the at least one processor will cause the currency transaction data processing system to repeatedly:
multiply spot rates for a defined group of currencies by covariance adjusted currency weights, obtained from storage and previously calculated from competitive weighting for the defined group of currencies, to generate current weighted currency values for each of the currencies in the defined group;
normalize the current weighted currency values to obtain normalized currency values; and
generate the currency index as an average of the normalized currency values.

61. The apparatus of claim 60, wherein:
the covariance adjusted currency weights obtained from the storage resulted from analysis performed in the currency transaction data processing system which calculated a weighted combination of trade weights and investor flows for the defined group of currencies relative to a focus currency and that have been modified to account for covariance among the currencies of the defined group.

62. The apparatus of claim 60, wherein the currency transaction data processing system further comprises:
an exchange system configured to
i) receive bids and offers for a financial instrument linked to the currency index; and
ii) match the received bids and offers for the financial instrument.

63. An apparatus comprising:
a processor;
storage, accessible by the processor;
first programming in the storage, executable by the processor, comprising at least one of a trade weight calculation module or an investor flow weight calculation module;
second programming in the storage, executable by the processor, comprising a covariance adjustment module configured to perform a covariance adjustment on results of executing the first programming; and
third programming in the storage, executable by the processor, comprising an index generation module configured to convert a set of covariance adjusted weightings for specific currencies and individual spot currency prices for the specific currencies into an index, publish the index, and periodically update the index.
